(19) United States
(12) Patent Application Publication
(10) Pub. No.: US 2014/0348146 A1
(43) Pub. Date: Nov. 27, 2014

(54) TRANSITION PERIOD FOR DUAL CONNECTIVITY

(71) Applicant: Nokia Corporation, Espoo (FI)

(72) Inventors: Esa Mikael Malkamäki, Espoo (FI); Jari Petteri Lunden, Espoo (FI); Elena Virtej, Espoo (FI); Antti Sorri, Helsinki (FI); Martti Johannes Moisio, Vantaa (FI)

(73) Assignee: Nokia Corporation, Espoo (FI)

(21) Appl. No.: 14/276,664

(22) Filed: May 13, 2014

Related U.S. Application Data
(60) Provisional application No. 61/825,939, filed on May 21, 2013.

(51) Int. Cl. H04W 72/04; H04J 3/16

(52) U.S. Cl. CPC H04W 72/0446; H04J 3/16
USPC 370/337; 370/336

(57) ABSTRACT

Methods and apparatus, including computer program products, are provided for dual connectivity. In one aspect there is provided a method. The method may include alternating access, by a user equipment during a transition between a first base station and a second base station, to the first base station and the second base station, wherein the alternating is performed during the transition in accordance with a schedule. Related apparatus, systems, methods, and articles are also described.

### FIELD

The subject matter described herein relates to wireless.

### BACKGROUND

A user equipment may implement dual connectivity using for example two radios, in which a first radio accesses a first of the two simultaneous connections and a second radio accesses a second of the two simultaneous connections. However, the user equipment may also implement a single radio to access the two connections. In the single radio case, the user equipment has a single radio frequency chain for receive or transmit, so dual connectivity may be implemented using time domain multiplexing (TDM). This TDM approach may comprise a TDM pattern defining when a user equipment switches between two cells, such as a macrocell/base station and a small cell/base station for access, listening, and/or the like.

### SUMMARY

Methods and apparatus, including computer program products, are provided for dual connectivity.

In some example embodiments, there may be provided a method. The method may include alternating access, by a user equipment during a transition between a first base station and a second base station, to the first base station and the second base station, wherein the alternating is performed during the transition in accordance with a schedule.

In some variations, one or more of the features disclosed herein including the following features can optionally be included in any feasible combination. The schedule may be configured by radio resource control (RRC) signaling. The schedule may be configured such that hybrid automatic request repeat operation can be carried in links to both the first base station and the second base station. The transition may be preceded by a first period and followed by a second period, wherein the first period, the transition, and the second period form a time division multiple access pattern defining when the user equipment is allowed to access the first base station and the second base station. The first base station provides at least one of a primary cell, an anchor cell, a master cell, or a macrocell, and the second base station provides at least one of a secondary cell, an assisting cell, a slave cell, or a small cell. The user equipment may access the first base station and the second base station using a single transceiver.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts an example of a system configured for dual connectivity, in accordance with some exemplary embodiments;

FIGS. 2, 3A, 3B, 4A, and 4B depict examples of transitions scheduled for dual connectivity, in accordance with some exemplary embodiments;

FIG. 5 depicts an example process for using transitions scheduled for dual connectivity, in accordance with some exemplary embodiments;

FIG. 6 depicts an example of a user equipment, in accordance with some exemplary embodiments; and

FIG. 7 depicts an example of a base station, in accordance with some exemplary embodiments.

Like labels are used to refer to same or similar items in the drawings.

### DETAILED DESCRIPTION

Dual connectivity may be a way of addressing some of the issues related to heterogeneous networks including macrocells and small cells. When a user equipment is served simultaneously by a macrocell including a macro base station and a small cell including a small cell base station, this dual connectivity may provide some throughput gains as the user may be served with more radio resources, benefit from being scheduled in a better one of the cells, and experience improved mobility robustness as the user equipment can retain the macrocell as a primary cell (PCell) even if the connection to the small cell is lost/dropped.

Although dual connectivity may operate well at a user equipment having at least a dual transmit/receive radio frequency (RF) chain, a user equipment not having dual transmit/receive chains, such as a non-carrier aggregation (CA) capable device or a CA capable device that does not support the needed band combination, may implement dual connectivity using a time division multiplexing (TDM) approach, where the user equipment is connected to both the macrocell/base station and small cell/base station but switches, per a schedule, its receive/transmit chain between the two cells (for example, the user equipment is connected to both the macrocell and small cell, but does not transmit/receive simultaneously to/from both).

In some example embodiments, the subject matter disclosed herein may support dual connectivity in devices not configured to dedicate dual transmit/receive chains to two cells (for example, devices that are non-CA capable or do not support the band combination needed to receive from and/or transmit to the two cells simultaneously). In some example embodiments, the user equipment may be configured with a TDM pattern to enable the user equipment to switch between cells, such as between a macro base station and a small cell base station operating on different frequencies, although other types of cells may be used as well. This TDM pattern may comprise a fixed TDM pattern configured to schedule the user equipment between cells. For example, the TDM pattern may allow the user equipment to be served mainly by a small cell base station serving a small cell, but this TDM pattern may also allow the user equipment to switch, based on a schedule, its receiver/transmitter chain from a carrier frequency of the small cell base station to another carrier frequency of the macro base station in order to allow the user equipment to receive information, such as radio resource control (RRC) signaling, a signaling radio bearer (SRB) from the macro base station including the macrocell, and the like.

The user equipment may spend some, if not most, of the time in the small cell and switch its receiver/transmitter chain to the carrier frequency of the macro base station for a sufficiently brief time to monitor/receive the RRC signaling or SRB as well as to perform measurements. For example, the user equipment may be configured with a TDM pattern, and this pattern may prompt the user equipment to tune to the macro base station for about only 5 subframes out of every 80 ms, although other patterns and times may be used as well. However, when the user equipment requires extended access to the macro base station (for example to receive a retransmission from the macro base station, receive or transmit additional data, and/or the like), the user equipment may choose (although the network or macro base station may choose for the user equipment) to remain at the macro base station for a longer period of time before returning to the small cell. Furthermore, during the transitions between cells when the user equipment switches from a first cell to another cell, there may remain some pending transmissions and/or retransmissions that would need handling, but delaying those until the user equipment returns back to the macrocell/base station may cause unnecessary and extended delays.

In some example embodiments, the subject matter disclosed herein may provide a way to handle transitions between cells. These transitions represent one or more times or subframes, when the user equipment schedules to switch between a macrocell/base station and a small cell/base station. Moreover, during the transitions, such as transition 215A and the like described further below, there may be pending data transmissions or retransmissions waiting to be sent. Furthermore, the transition may include an alternating pattern enabling the user equipment to access both the macrocell and the small cell.

In some example embodiments, user equipment may be configured with a TDM pattern according to which it monitors either a macrocell or a small cell Physical Downlink Control Channel (PDCCH) (for example, about 50 ms monitoring the macrocell every 1000 ms, although longer periodicity patterns, other periodicities, or patterns may be used as well). Switching between different carrier frequencies requires some switching time (for example, about, or up to, 1 ms may be used for switching between cells/frequencies).

Further, a transition pattern may, in some example embodiments, be used during the transition between cells. This transition pattern may represent one or more times or subframes, and may comprise an alternating pattern during the transition between a macro base station and a small cell base station. Moreover, this alternating pattern may be used to schedule communications between the user equipment and a base station, such as a macro eNB base station and/or a small cell base station. For example, the transition pattern may be configured to enable operation of certain protocols or commands at the user equipment and the base station (for example, hybrid automatic repeat request (HARQ) can be used on the uplink and the downlink during the transition). In some example embodiments, this transition pattern may be used between the user equipment and a base station until the user equipment is ready to return to a normal TDM pattern operation at the small cell/base station (for example, after traffic from the macro base station/cell is handled).

In some example embodiments, during the transition, the user equipment may follow a frequently alternating pattern that allows HARQ to operate on both sides, for example, from the user equipment to the macrocell/base station and from the user equipment to the small cell/base station. In some example embodiments, the user equipment may use the alternating pattern for a short while when switching between eNB base stations. In some embodiments, only this alternating pattern may be used for communication with the eNB base station(s). Until macrocell traffic is handled and the user equipment is ready to return more or less fully to the small cell/base station, there may remain a rather infrequent pattern still, such as for example 5 ms every 80 ms, from which the user equipment and the network may switch to this more extensive alternating pattern based on need for the alternating pattern.

In some example embodiments, the user equipment may not be using a TDM pattern except when switching from a cell to another cell (for example, from dual connected macrocell to small cell or vice versa). Before the transition, the user equipment may be served only by the macrocell/base station and after the transition only by the small cell/base station or vice versa. During the transition, the transition pattern allows the user equipment to be served by both of the cells/base stations.

In some example embodiments, the user equipment may be served by one cell (e.g. a macrocell or a small cell), in which case the transition pattern may be configured and/or activated for a period of time to allow the user equipment to communicate with another cell in a TDM manner. After the communication with the other cell is finished, the TDM pattern may be de-configured and/or deactivated, and the user equipment may continue communicating with just one cell.

In some example embodiments, the transition pattern disclosed herein and its frequently alternating pattern may be used when there is a certain process, such as a voice over internet protocol (VoIP) call is ongoing via the macro base station. The extended use of the transition pattern may allow frequent communication with both cells. Furthermore, this alternating, transition pattern may, in some example embodiments, be used until all the on-going retransmissions are handled. In addition, the network may align the user equipment's transmissions with the incoming alternating, transition pattern before a pattern is applied, so that there will not be any conflicting acknowledgment (ACK) or negative-ACK (NACK), or HARQ retransmissions when the alternating, transition pattern starts. The uplink (UL) may follow the same or similar pattern, but shifted.

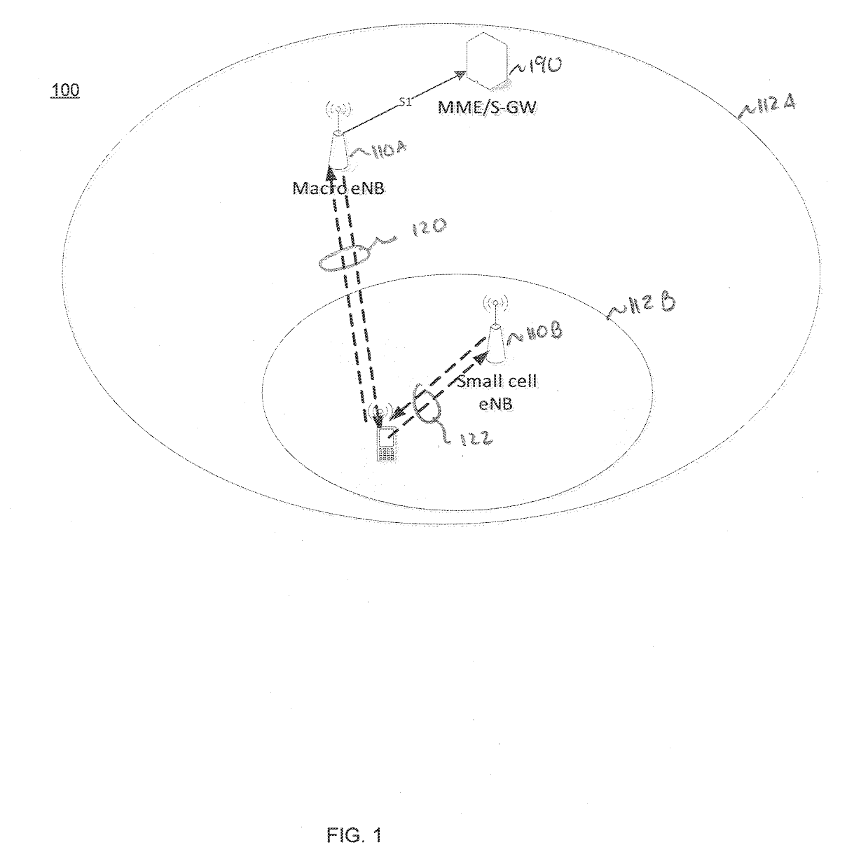

FIG. 1 depicts an example system 100 including a user equipment 114 and one or more wireless access points, such as such as an evolve node B (eNB) base station 110A (for example, an anchor or master eNB base station) serving macrocell 112A and another base station (e.g., an assisting or slave eNB base station) serving a small cell 112B, although other types of cells and base stations may be used as well including PCells, SCells, and/or the like. For example, the user equipment has a macrocell as a PCell and a small cell as an SCell. The system 100 may further include network nodes, such as a mobility management entity or a serving gateway 190 coupled via one or more backhaul links to eNB base station 110A (also referred to herein as macro base station 110A) or small cell eNB 110B (link not shown in the figure). Also, the eNBs 110A and 110B can be connected to each other with an interface such as an (enhanced) X2 interface or similar (not shown in the figure). Although FIG. 1 depicts a certain quantity of devices and a certain configuration, other quantities and configurations may be used as well.

In the example of FIG. 1, user equipment 114 may use a single radio, such as a single RF receive and/or transmit chain, to access the dual connections 120 and 122 by switching the single radio between a first carrier associated with macro base station 110A and a second carrier associated with base station 110B (also referred to herein as a small cell base station). In some example embodiments, user equipment 114 may implement a TDM pattern defining when the user equipment 114 can communicate with the small cell base station 110B. The TDM pattern may also define when user equipment 114 can communicate with the macro base station 110B. For example, the TDM pattern may define that user equipment 114 can communicate (for example, receive, listen, access, measure, transmit, and/or the like) with macro base station 110A 5 millisecond (ms) out of every 80 ms, so that user equipment 114 has a 6 subframe gap in small base station 110B reception to communicate with/receive from/listen to macro base station 110 for 5 subframes), although other patterns may be used as well. To illustrate further, user equipment 114 may, during a gap, receive via the single radio at user equipment 114 a physical downlink control channel (PDCCH) transmitted by macro base station 110A. After listening to PDCCH (possibly several times depending on the length of the gap and DRX configuration if any), user equipment 114 may then tune its radio to return to the small cell base station 110B.

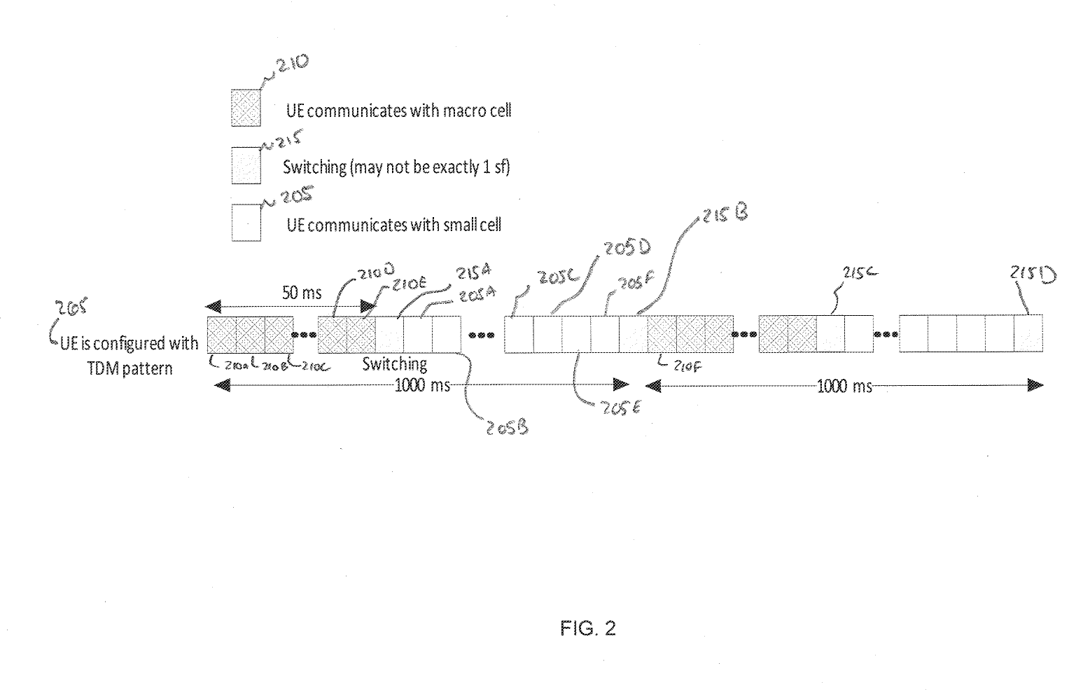

FIG. 2 depicts an example of a TDM pattern 265. The TDM pattern 265 may define when the user equipment 114 communicates with small cell base station 110B (for example, un-shaded periods 205A-F and so forth), and define when user equipment 114 communicates with macro base station 110A (for example, periods 210A-F and so forth).

In the example of FIG. 2, user equipment 114 may monitor either the macro base station or the small base station in accordance with the TDM pattern 265. To illustrate, user equipment 114 may monitor the macro base station for about 50 ms 210A-E, switch at 215A (which may account for at least about 1 ms, depending also on the relative timing of the macro and small cell base station transmissions), and then monitor the small cell at 205A about 1000 ms or longer before returning to monitor the macro base station at 210F, where the switch between cells/base station is scheduled at 215B. The switching here refers to changing the carrier frequency in the user equipment (for example, switching the receiver/transmitter from one carrier frequency to another). Some switching time (for example, less than 1 ms) is required to allow radio frequency (RF) components change frequency and to stabilize after the change, for instance the frequency oscillators, automatic gain controllers (AGC), and the like. Moreover, channel estimation and other physical layer functions may require some time after the change of the frequency before they can provide sufficient performance. The switching time may take these components, channel estimation, and other functions into account. This switching time may be required every time the carrier frequency is changed (for example, it may be required several times during the transition period, such as when the transition pattern disclosed herein is applied).

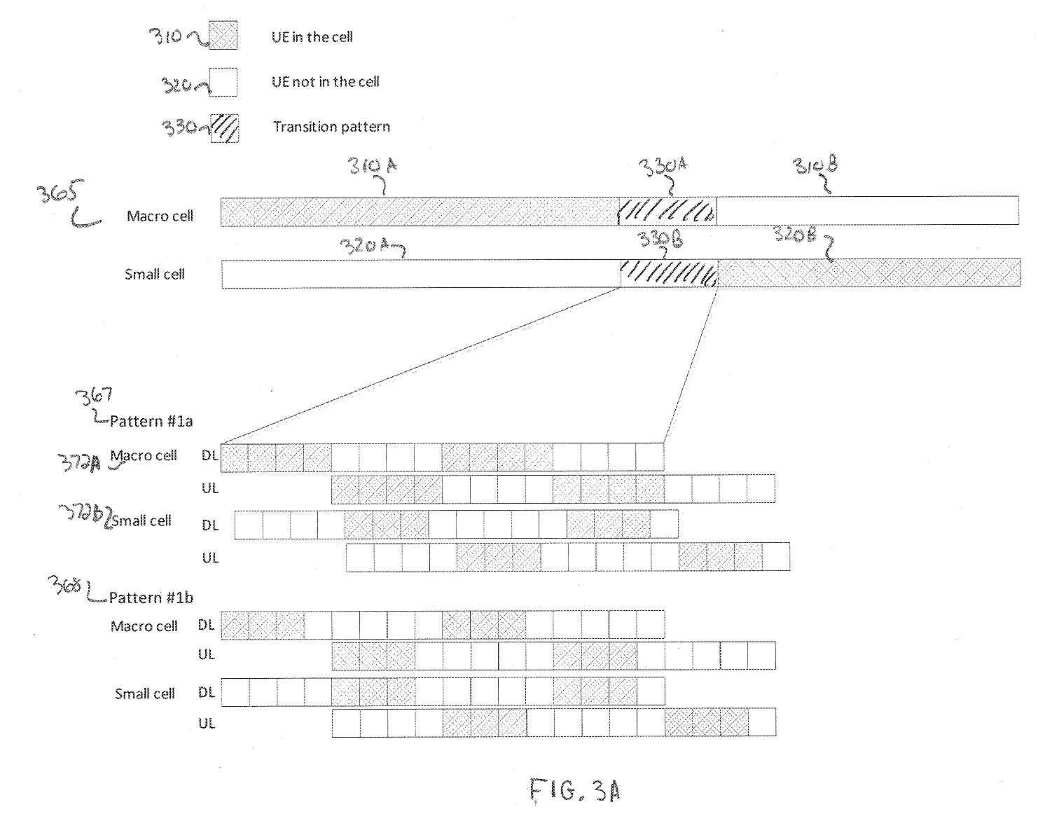

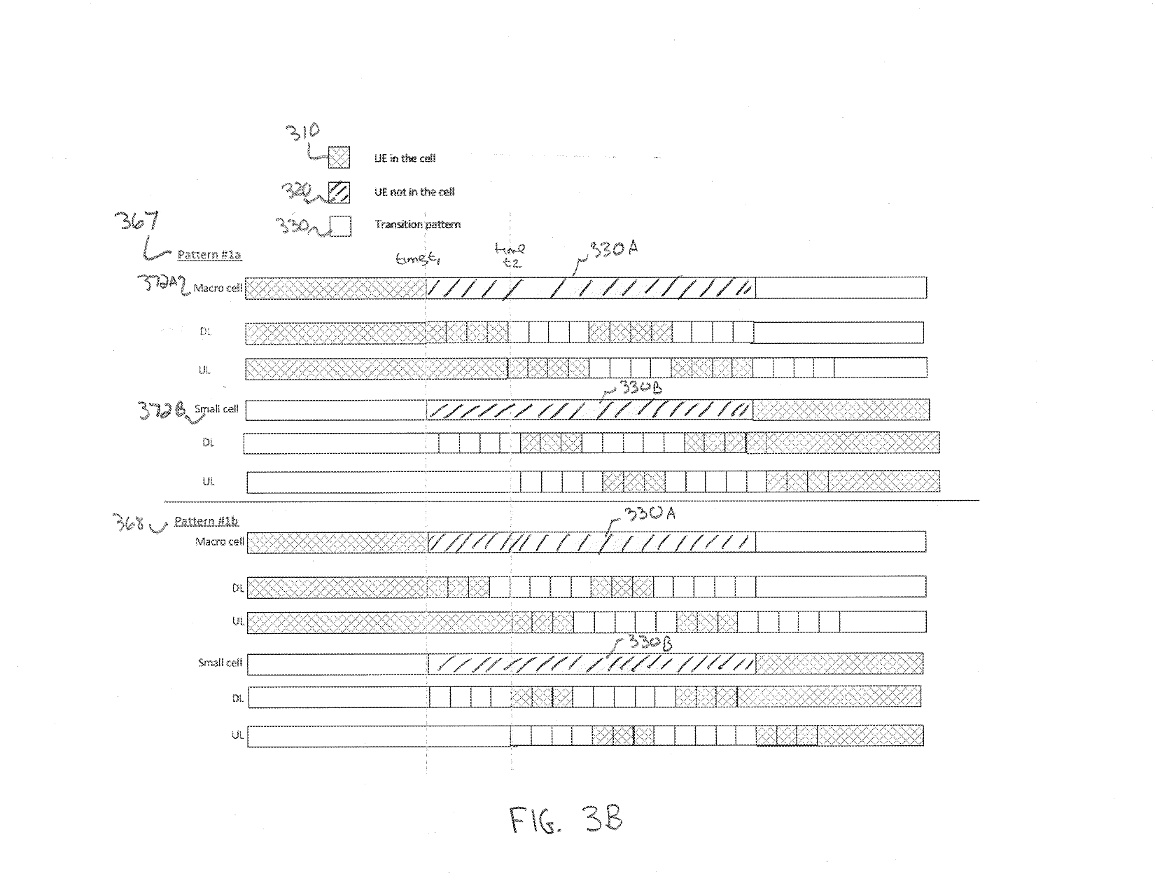

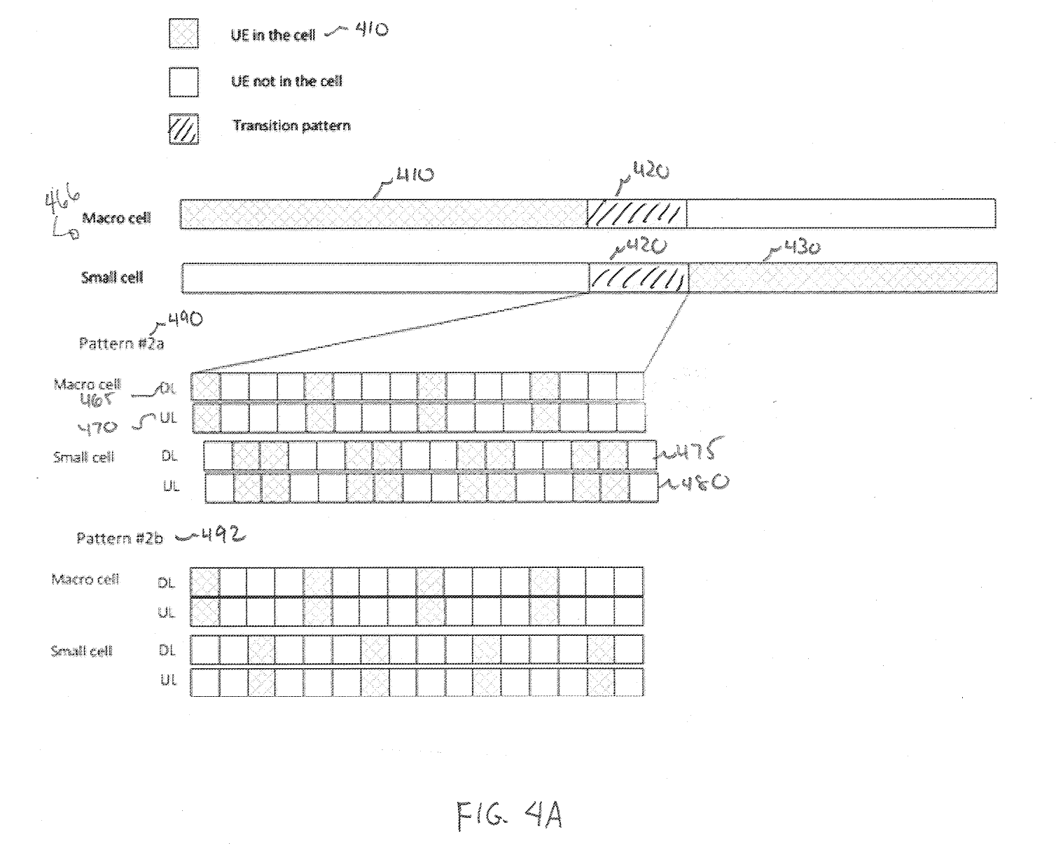

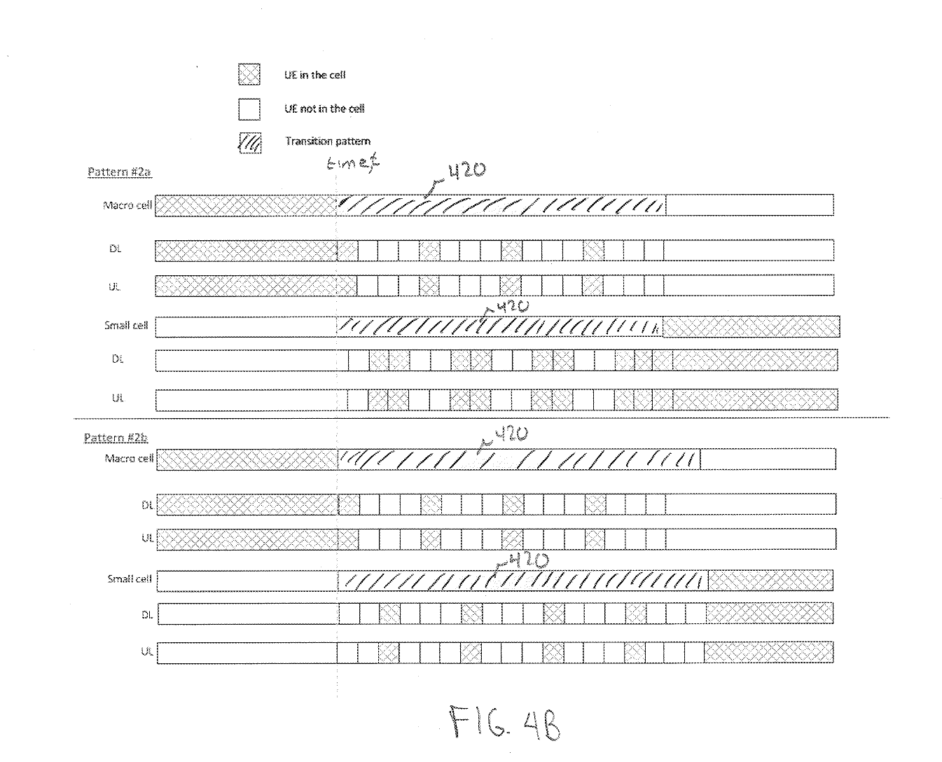

FIG. 2 shows a generic TDM pattern where user equipment is communicating with macro and small cells according to a TDM pattern. FIG. 2 does not explicitly show the transition pattern, which are shown in FIGS. 3 and 4. During the transition starting at for example 215A, user equipment 114 may, in some example embodiments, follow a transition pattern (also referred to as an alternating pattern), examples of which are described further below with respect to FIGS. 3 and 4. This transition pattern may be configured to enable operation of for example, hybrid automatic repeat request (HARQ) on the uplink(s) and the downlink(s) as well as other signaling. Furthermore, this transition pattern may, as noted, be an alternating pattern for a certain period during each of the transitions starting in 215A-D, and may thus last for substantially longer than one subframe.

Moreover, this alternating, transition pattern may be used for communicating between the user equipment and a base station. For example, when the user equipment has traffic to receive from or transmit to the macro base station and a cell change occurs at 215A, user equipment 114 and macro base station 110A as well as the small cell base station 110B may implement an alternating, transition pattern where user equipment is receiving from, and/or transmitting to, both base stations in an alternating manner until pending traffic from the macro base station is handled, at which time user equipment 114 may fully return to small cell base station 110B. Furthermore, the user equipment and the network may, in some example implementations, switch to the more extensive alternating, transition pattern to provide the user equipment with extended access to the macrocell based on need (for example, when traffic is pending, retransmission are pending, and/or a voice over internet protocol (VoIP) call is ongoing via the macro base station, and the like).

The network including macro base station 110A and the small cell base station 110B may align user equipment 114 and its transmissions with the incoming alternating, transition pattern before the alternating, transition pattern is applied, so that there will not be any conflicting acknowledgment (ACK) or negative-ACK (NACK) or HARQ retransmissions when the alternating pattern starts. The uplink (UL) may follow the same or similar alternating, transition pattern, but shifted.

FIG. 3A depicts an example TDM pattern 365, in accordance with some example embodiments. The user equipment 114 may be configured to receive from the macro base station at 310A, and thus not receive the small cell base station at 320A. However, the user equipment 114 may receive from the small cell at 320B, and thus not receiving the macrocell base station at 310B. During 330A and 330B time period, a transition occurs at the user equipment 114 from one cell (or base station) to another cell (or base station). During the transition, another pattern, such as transition pattern #1 a 367 or transition pattern #1 b 368, may be implemented. In the example of FIG. 3A, the transition pattern during the transition period 330A/330B may be configured as pattern #1a 367 or transition pattern #1 b 368.

As noted, the transition period may, in some example embodiments, be extended until pending data is handled and the user equipment is ready to fully “switch” to the small cell base station 110B. Without in any way limiting the scope, interpretation, or application of the claims appearing below a benefit of using transition patterns as shown for example at FIG. 3A as well as FIG. 4A is that the transition pattern supports the current timing of HARQ acknowledgements and retransmissions. Referring to patterns 367 and 368 for example, the base station may send an ACK/NACK in 4 subframes of the DL after a transmission in the UL and a possible retransmission is transmitted in 4 subframes of the UL after a NACK (for example, subframes after the previous transmission). A similar process may occur for DL transmissions, but there due to asynchronous HARQ, the retransmission may also be scheduled with a longer delay than 8 subframes after the previous transmission. Without in any way limiting the scope, interpretation, or application of the claims appearing below a benefit is that the transition pattern can support smooth and fast switching between cells: transmissions in the source cell can be finished while new transmissions can be started in the target cell “simultaneously.”

The length of the TDM pattern when the UE monitors the macro (for example, 310A) or the small cell (for example, 320B) may vary and be either shorter duration (for example, 80 ms) or longer duration (for example, 1000 ms).

Depending on whether the macrocell/base station and small cell/base station are frame-synchronized, the transitions and associated switching between cells/base stations can yield a loss of about 1 or 2 subframes out of 8 subframes (see, for example, transition pattern #1a 367 or transition pattern #1b 368). FIG. 3A further illustrates both downlink (DL) and uplink (UL) cases. For example, with transition pattern #1a 367, the macrocell DL and the macrocell UL do not occur simultaneously as shown at 372A and 372B, so the user equipment may either transmit or receive in the macrocell (which would also be the case in the small cell as shown by the pattern at 372B). Accordingly, the macrocell/base station DL and the small cell/base station UL are simultaneous as shown by the patterns at 372A and 372B. Similarly, the macrocell/base station UL and small cell/base station DL are simultaneous as shown by the patterns at 372A and 372B. Referring to transition pattern #1 b 368, the UL and DL switching are simultaneous, whereas in Pattern 1 a the UL and DL switching are not simultaneous (for example, UL switching happens at different time than DL switching).

FIG. 4A illustrates another example/configuration for the transition pattern, that may be used by macro and small cells during the transition period (from one cell to another, for example, from macro cell to small cell), in accordance with some example embodiments. FIG. 4A depicts both uplink (UL) and downlink (DL) pattern. Pattern #2a may be applied in the case when macro cell and small cell subframe timing is such that there is time to do switching without waiting a full subframe. Pattern #2b may be applied in the case when macro and small cells are subframe synchronized/aligned, or the timing is such that there is not enough time to switch without reserving additional subframe for switching synchronized.

In FIG. 4A as in FIG. 3A, the switching overhead used during the transition subframes is 25% as 1 out of 4 subframes are used for the transitions. If macro and small cells are synchronized (or otherwise timed so that 1 subframe out of 4 is not enough for switching) on subframe level, the switching overhead may become 2 out of 4 subframes (every switching may takes up to 1 ms). As noted, the transition period 420 and the corresponding transition pattern #2a 490 and pattern #2b 492 may, in some example embodiments, be extended until pending data is handled and the user equipment is ready to return to the small cell base station 110B. Similarly, the transition period 330A/330B and the corresponding transition pattern #1 a 367 and pattern #1 b 368 may, in some example embodiments, be extended until pending data is handled and the user equipment is ready to return to the small cell base station 110B or to macro cell 110A.

In some other embodiments, the transition pattern may be applied for example for some predetermined duration, or the duration may be signaled in the configuration or activation of the pattern, or it may be explicitly signaled when the pattern ends. The length of the pattern may have for example, one or more repetitions of the same basic pattern. The alternating, transition pattern may be configured shorter or longer depending for example on the number of retransmissions, amount of pending data, or vary dynamically based on how long it takes to finish the transmissions in the cell. Timers may also be defined for the transition period. In some example embodiments, DRX timers may be utilized, and the transition may cease when DRX timers (such as DRX inactivity timer and/or DRX retransmission timer) expire.

In some example embodiments, the timing of transition pattern(s), such as the switching patterns shown in FIGS. 3A and 4A, is configured so that the acknowledgements (ACK) and/or negative-ACK (NACK) follow the transmission by 4 subframes, and the synchronous retransmission comes 4 subframes after that. This pattern has a periodicity of 4 and is synchronized in the macrocell and small cell (although subframe-level synchronization may not be implemented nor needed).

When TDM dual connectivity transition pattern is used, such as shown in FIGS. 3A and 4A, the small cell/base station and macrocell/base station may use distinct sets of HARQ processes (or, for example, identifiers, IDs) for the user equipment 114, so that user equipment 114 does not need to have more than 8 HARQ buffers. For example, some fixed subsets of HARQ processes (or IDs) may be reserved for each side depending on the pattern.

To illustrate further for example, in a transition pattern (for example, as shown in FIGS. 3A and 4A), two HARQ processes (for example, having IDs 1 and 2) may be reserved for the macrocell/base station and the remaining ones for the small cell/base station. Due to some subframes being “lost” in switching, there may also be provided extra processes (or IDs) that may be allocated to either cell. Alternatively or additionally, those extra processes may be reserved for the cell that was active (or had larger portion of the resources) before the transition to allow easier preparation for transition with more HARQ processes in use. Alternatively or additionally, those extra processes may be reserved for the cell that is becoming active. Which HARQ processes are used for communicating with which cell may be negotiated between the cells over the backhaul connection (for example, X2 or Xn interface) or may be fixed in a specification using rules that for example reserve certain processes (or IDs) for each side.

The downlink HARQ may be configured to use the configured alternating transition pattern (for example, as shown in FIG. 3A and FIG. 4A at 367, 368, 490, and 492), during the transition period 420 since downlink HARQ is asynchronous (for example, retransmission can be scheduled by the macro eNB base station at any time during a discontinuous reception (DRX) retransmission window). On the other hand, uplink HARQ is synchronous, and, as a consequence, the user equipment may need to be scheduled using the specific HARQ processes supported during the transition period even before the transition starts since otherwise the intended HARQ process may not be available during the transition period.

Both the larger scale TDM pattern (for example, 5 ms every 80 ms in macrocell, 50 ms every 1000 ms in macrocell, TDM pattern 365, TDM pattern 466, and/or the like) and the smaller scale transition patterns (for example, transition patterns 367, 368, and 490) may be configured at the user equipment via for example signaling, such as RRC signaling. The user equipment may also be configured with several switching patterns, and this selection may be done by for example a media access control (MAC) control element (CE) or an indication could be added to PDCCH. There may be also signaling between the macro base station and small cell base station to negotiate, synchronize or configure the TDM pattern and/or the transition pattern. This may take place over interfaces that are available between the cells, such as X2 or Xn.

FIGS. 3A and 4B provide additional details for the patterns shown at FIGS. 3A and 4A, where the transition period is explicitly shown by the transition patterns. In FIG. 3B, the transition periods from FIG. 3A (330A and 330B) is explicitly illustrated by the transition patterns 1a (367) and pattern 1b (368), for both macro cell and small cell for the UL and DL. Similarly, in FIG. 4B, the transition periods from FIG. 4A (420) is explicitly illustrated by the transition patterns 2a (490) and pattern 2b (492), for both macrocell and small cell for the UL and DL.

Before providing additional description regarding the dual connectivity transition patterns disclosed herein, the following provides additional details regarding example implementations of some of the devices.

The base stations 110A-B may, in some example embodiments, be implemented as an evolved Node B (eNB) type base station consistent with standards, including the Long Term Evolution (LTE) standards, such as 3GPP TS 36.201, Evolved Universal Terrestrial Radio Access (E-UTRA); Long Term Evolution (LTE) physical layer; General description, 3GPP TS 36.211, Evolved Universal Terrestrial Radio Access (E-UTRA); Physical channels and modulation, 3GPP TS 36.212, Evolved Universal Terrestrial Radio Access (E-UTRA); Multiplexing and channel coding, 3GPP TS 36.213, Evolved Universal Terrestrial Radio Access (E-UTRA); Physical layer procedures, 3GPP TS 36.214, Evolved Universal Terrestrial Radio Access (E-UTRA); Physical layer—Measurements, and any subsequent additions or revisions to these and other 3GPP series of standards (collectively referred to as LTE standards). The base station may also be configured as a small cell base station, such as a femtocell base station, a home evolved node B base station, a picocell base station, a WiFi access point, and/or a wireless access point configured in accordance with other radio access technologies as well. Moreover, the base stations may be configured to provide carrier aggregation to a given user equipment. For example, the dual connections may correspond to carrier aggregation carriers, such as a primary carrier or cell (PCell) provided by a macro eNB (or anchoring or master eNB) base station and another carrier by a small cell or secondary cell (SCell) provided by a small cell (or assisting or slave) eNB.

The user equipment, such as user equipment 114, may be implemented as a mobile device and/or a stationary device. The user equipment are often referred to as, for example, mobile stations, mobile units, subscriber stations, wireless terminals, tablets, smart phones, or the like. A user equipment may be implemented as, for example, a wireless handheld device, a wireless plug-in accessory, a wireless transceiver configured in a stationary device, a wireless transceiver configured in a mobile device and/or the like. In some cases, user equipment may include a processor, a computer-readable storage medium (e.g., memory, storage, and the like), a radio interface(s), and/or a user interface. In some example embodiments, the user equipment may be configured to receive a TDM configuration defining when to switch between cells (for example, between a macrocell and a small cell, an SCell and a PCell, and/or any other cells, carriers, and/or the like.

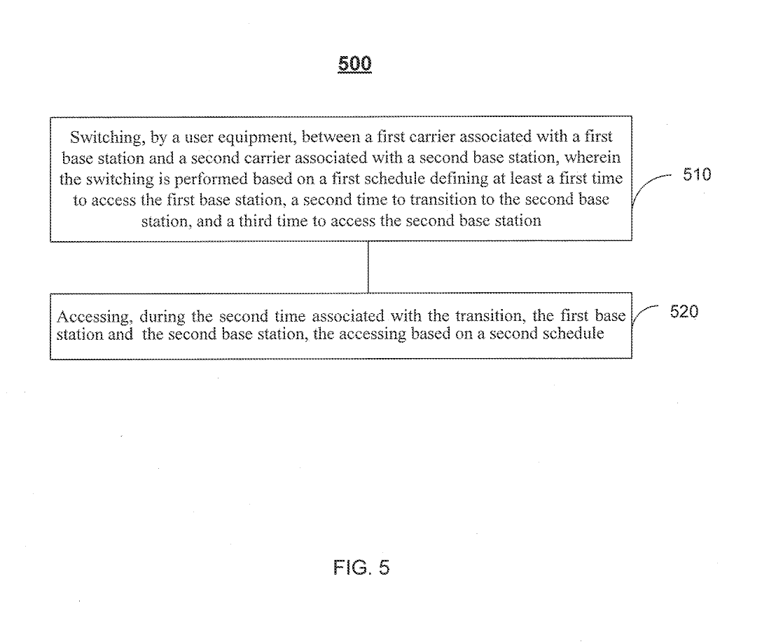

FIG. 5 depicts an example of a process for transition periods, in accordance with some example embodiments.

At 510, the user equipment may switch between a first carrier associated with a first base station and a second carrier associated with a second base station, wherein the switching is performed based on a first schedule defining at least a first time to access the first base station, a second time to transition to the second base station, and a third time to access the second base station. For example, user equipment 114 may switch from macrocell base station 110A and small cell base station per a TDM schedule, such as schedules 365. Moreover, the transitions, such as 330A-B and 420, may also be defined by the TDM schedule.

At 520, the user equipment may access, during the second time corresponding to the transition, the first base station and the second base station, in accordance with some example embodiments. For example, the user equipment may alternate, during a transition period, between a first base station and a second base station, access to the first base station and the second base station. And, this alternating access may be in accordance with an alternating pattern, such as patterns 367, 368, 490, 492, and the like, that allows protocols or commands to be carried on to the first and second base stations. For example, the user equipment may engage in distinct HARQ processes to the first base station and the second base station during the transitions. Furthermore, the alternating patterns may allow synchronous access to the DL and UL, although asynchronous access may be provided. Moreover, these transition patterns may be extended in time until the user equipment no longer has a need to remain at a given cell, such as a macro base station (for example, when there are no pending transmission or retransmission to be handled), and can thus return to another cell, such as a small cell.

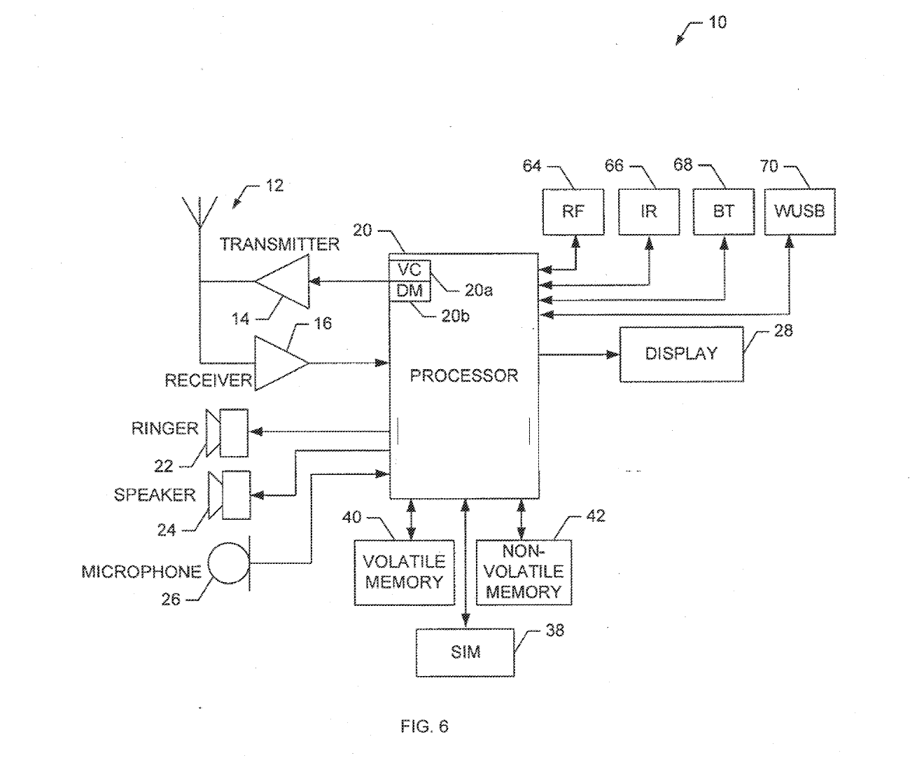

FIG. 6 illustrates a block diagram of an apparatus 10, which can be configured as user equipment in accordance with some example embodiments.

The apparatus 10 may include at least one antenna 12 in communication with a transmitter 14 and a receiver 16. Alternatively transmit and receive antennas may be separate.

The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise processor 20 may be configured to control other elements of apparatus 10 by effecting control signaling via electrical leads connecting processor 20 to the other elements, such as for example, a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 6 as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as for example, Institute of Electrical and Electronics Engineers (IEEE) 802.11, 802.16, and/or the like. In addition, these signals may include speech data, user generated data, user requested data, and/or the like.

The apparatus 10 may be capable of operating with one or more air interface standards, communication protocols, modulation types, access types, and/or the like. For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as for example, Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as for example, Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as for example, LTE Advanced and/or the like as well as similar wireless communication protocols that may be subsequently developed. Further, the apparatus may be capable of operating in accordance with carrier aggregation.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as for example, a web browser. The connectivity program may allow the apparatus 10 to transmit and receive web content, such as for example, location-based content, according to a protocol, such as for example, wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as for example, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as for example, a keypad 30 (which can be a virtual keyboard presented on display 28 or an externally coupled keyboard) and/or other input devices.

As shown in FIG. 6, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as for example, an infrared (IR) transceiver 66, a Bluetooth (BT) transceiver 68 operating using Bluetooth wireless technology, a wireless universal serial bus (USB) transceiver 70, and/or the like. The Bluetooth transceiver 68 may be capable of operating according to low power or ultra-low power Bluetooth technology, for example, Wibree, radio standards. In this regard, the apparatus 10 and, in particular, the short-range transceiver may be capable of transmitting data to and/or receiving data from electronic devices within a proximity of the apparatus, such as for example, within 10 meters, for example. The apparatus 10 including the WiFi or wireless local area networking modem may also be capable of transmitting and/or receiving data from electronic devices according to various wireless networking techniques, including 6LoWpan, Wi-Fi, Wi-Fi low power, WLAN techniques such as for example, IEEE 802.11 techniques, IEEE 802.15 techniques, IEEE 802.16 techniques, and/or the like.

The apparatus 10 may comprise memory, such as for example, a subscriber identity module (SIM) 38, a removable user identity module (R-UIM), and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions of the user equipment/mobile terminal. The memories may comprise an identifier, such as for example, an international mobile equipment identification (IMEI) code, capable of uniquely identifying apparatus 10. The functions may include one or more of the operations disclosed herein with respect to the user equipment, such as for example, the functions disclosed at process 500 (for example, switching between PCell and SCells based on a TDM configuration, switching during the transitions based on a transition pattern and/or the like). The memories may comprise an identifier, such as for example, an international mobile equipment identification (IMEI) code, capable of uniquely identifying apparatus 10. In the example embodiment, the processor 20 may be configured using computer code stored at memory 40 and/or 42 to enable the user equipment to switch during the transitions based on a transition pattern and/or any other function associated with the user equipment or apparatus disclosed herein.

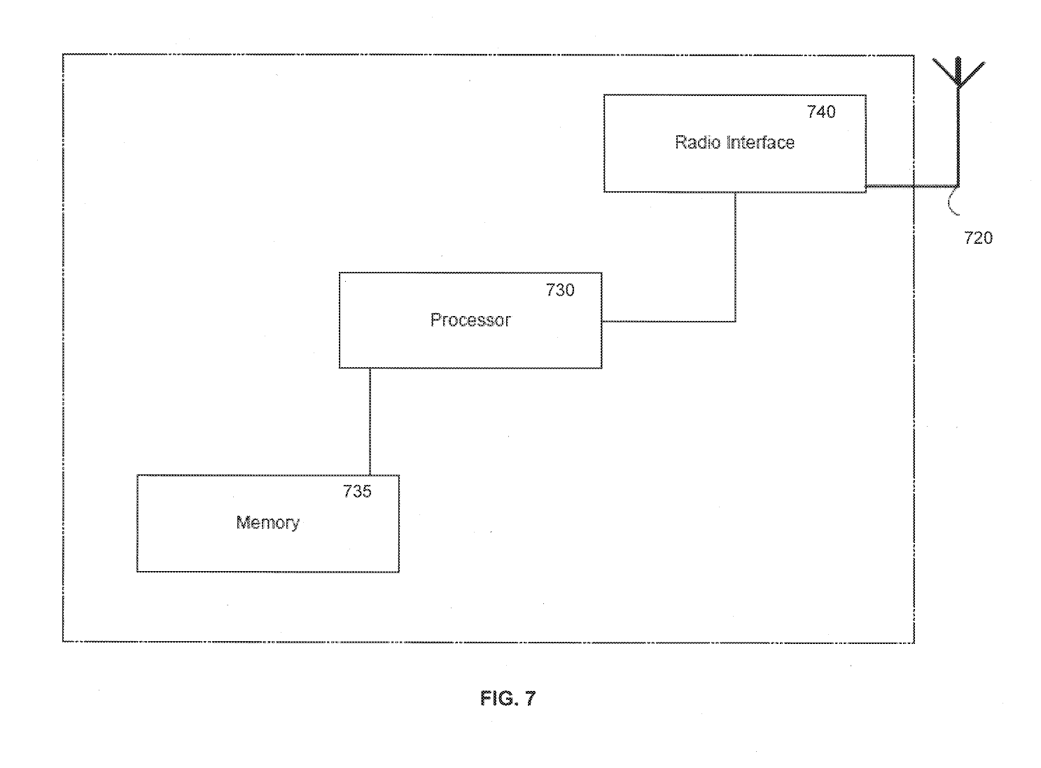

FIG. 7 depicts an example implementation of a network node, such as a base station, access point, and/or any other type of node. The network node may include one or more antennas 720 configured to transmit via a downlink and configured to receive uplinks via the antenna(s) 720. The network node may further include a plurality of radio interfaces 740 coupled to the antenna 720. The radio interfaces may correspond one or more of the following: Long Term Evolution (LTE, or E-UTRAN), Third Generation (3G, UTRAN, or high speed packet access (HSPA)), Global System for Mobile communications (GSM), wireless local area network (WLAN) technology, such as for example 802.11 WiFi and/or the like, Bluetooth, Bluetooth low energy (BT-LE), near field communications (NFC), and any other radio technologies. The radio interface 740 may further include other components, such as filters, converters (for example, digital-to-analog converters and/or the like), mappers, a Fast Fourier Transform (FFT) module, and/or the like, to generate symbols for a transmission via one or more downlinks and to receive symbols (for example, via an uplink). The network node may further include one or more processors, such as processor 730, for controlling the network node and for accessing and executing program code stored in memory 735. In some example embodiments, memory 735 includes code, which when executed by at least one processor causes one or more of the operations described herein with respect to a base station.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as for example, a computer or data processor, with examples depicted at FIGS. 6 and 7. A computer-readable medium may comprise a non-transitory computer-readable storage medium that may be any media that can contain or store the instructions for use by or in connection with an instruction execution system, apparatus, or device, such as for example, a computer. Moreover, some of the embodiments disclosed herein include computer programs configured to cause methods as disclosed herein (see, for example, FIGS. 1-4, process 500, and/or the like).

Without in any way limiting the scope, interpretation, or application of the claims appearing below, a technical effect of one or more of the example embodiments disclosed herein may include enhanced operation under dual-connectivity scenarios.

If desired, the different functions discussed herein may be performed in a different order and/or concurrently with each other. Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of the present invention as defined in the appended claims. Other embodiments may be within the scope of the following claims. The term “based on” includes “based on at least.”

What is claimed:

1. A method comprising:
alternating access, by a user equipment during a transition between a first base station and a second base station, to the first base station and the second base station,
wherein the alternating is performed during the transition in accordance with a schedule.

2. The method of claim 1, wherein the schedule is configured by radio resource control (RRC) signaling.

3. The method of claim 1, wherein the schedule is configured such that hybrid automatic request repeat operation can be carried in links to both the first base station and the second base station.

4. The method of claim 1, wherein the transition is preceded by a first period and followed by a second period, wherein the first period, the transition, and the second period form a time division multiple access pattern defining when the user equipment is allowed to access the first base station and the second base station.

5. The method of claim 1, wherein the first base station provides at least one of a primary cell, an anchor cell, a master cell, or a macrocell, and the second base station provides at least one of a secondary cell, an assisting cell, a slave cell, or a small cell.

6. The method of claim 1, wherein the user equipment accesses the first base station and the second base station using a single transceiver.

7. An apparatus comprising:
at least one processor; and
at least one memory including computer program code, the at least one memory and the computer program code configured to, with the at least one processor, cause the apparatus to at least perform:
alternate access, during a transition between a first base station and a second base station, to the first base station and the second base station,
wherein the alternating is performed during the transition in accordance with a schedule.

8. The apparatus of claim 7, wherein the schedule is configured by radio resource control (RRC) signaling.

9. The apparatus of claim 7, wherein the schedule is configured such that hybrid automatic request repeat operation can be carried in links to both the first base station and the second base station.

10. The apparatus of claim 7, wherein the transition is preceded by a first period and followed by a second period, wherein the first period, the transition, and the second period form a time division multiple access pattern defining when the apparatus is allowed to access the first base station and the second base station.

11. The apparatus of claim 7, wherein the first base station provides at least one of a primary cell, an anchor cell, a master cell, or a macrocell, and the second base station provides at least one of a secondary cell, an assisting cell, a slave cell, or a small cell.

12. The apparatus of claim 7, wherein the apparatus accesses the first base station and the second base station using a single transceiver.

13. A non-transitory computer-readable medium including computer program code, which when executed by at least one processor provides operations comprising:
alternating access, during a transition between a first base station and a second base station, to the first base station and the second base station,
wherein the alternating is performed during the transition in accordance with a schedule.

14. The computer program code of claim 13, wherein the schedule is configured by radio resource control (RRC) signaling.

15. The computer program code of claim 13, wherein the schedule is configured such that hybrid automatic request repeat operation can be carried in links to both the first base station and the second base station.

16. The computer program code of claim 13, wherein the transition is preceded by a first period and followed by a second period, wherein the first period, the transition, and the second period form a time division multiple access pattern defining when a user equipment is allowed to access the first base station and the second base station.

17. The computer program code of claim 13, wherein the first base station provides at least one of a primary cell, an anchor cell, a master cell, or a macrocell, and the second base station provides at least one of a secondary cell, an assisting cell, a slave cell, or a small cell.
